(19) United States
(12) Patent Application Publication
(10) Pub. No.: US 2005/0089109 A1
(43) Pub. Date: Apr. 28, 2005

(54) Apparatus and method for PAPR reduction in an OFDM communication system

(75) Inventors: Sung-Ryul Yun, Goesan-gun (KR); Sung-Eun Park, Suwon-si (KR); Jae-Yoel Kim, Gunpo-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/974,124

(22) Filed: Oct. 27, 2004

(30) Foreign Application Priority Data
Oct. 27, 2003 (KR) P2003-75188

(51) Int. Cl. H04K 1/10

(52) U.S. Cl. 375/260

(57) ABSTRACT

A method and apparatus for generating an impulsive wave in an OFDM communication system where L subcarriers are allocated to reserved tone locations among N subcarriers and data is carried on (N-L) subcarriers (L is less than N). In the method, a predetermined number of random sets each having L tone locations are created. Subcarriers are allocated to the L tone locations of each of the random sets without overlapping and IFFT-processed. A secondary peak value of the IFFT signal is stored. Tone location information having a lower secondary peak value than the stored secondary peak value is detected by fixing (L-1) tone locations and substituting subcarriers other than the subcarriers at the (L-1) tone locations one by one for the remaining one tone location. The tone location information is stored.

### PRIORITY

This application claims priority under 35 U.S.C. § 119 to an application entitled “Apparatus and Method for PAPR Reduction in an OFDM Communication System” filed in the Korean Intellectual Property Office on Oct. 27, 2003 and assigned Ser. No. 2003-75188, the contents of which are incorporated herein by reference.

### BACKGROUND OF THE INVENTION

1. Field of the Invention

The present invention relates generally to an OFDM (Orthogonal Frequency Division Multiplexing) system, and in particular, to an apparatus and method for reducing PAPR (Peak to Average Power Ratio).

2. Description of the Related Art

Mobile communication technology is currently evolving from the 3^{rd} generation mobile communication system to the 4^{th} generation mobile communication system. Beyond simple wireless communication services as provided in previous generation mobile communication systems, the 4^{th} generation mobile communication system aims at efficient interworking and integration between a wired communication network and a wireless communication network. In this context, techniques of providing data transmission services at a higher rate than the 3^{rd} generation mobile communication system are under going standardization.

A signal transmitted on a radio channel experiences multipath interference due to a variety of obstacles between a transmitter and a receiver in a mobile communication environment. The multipath radio channel is characterized by its maximum delay spread and transmission period. If the transmission period is longer than the maximum delay spread, no interference occurs between successive signals and the radio channel is referred to as a frequency non-selective fading channel.

However, if a single carrier scheme is used for high-speed data transmission with a short symbol period, ISI (Inter-Symbol Interference) causes signal distortion, accompanied by increased equalizer complexity. To solve this problem, an OFDM system was proposed.

OFDM is a special case of MCM (Multi-Carrier Modulation). A serial symbol sequence is parallelized and the parallel symbol sequences are modulated to orthogonal subcarriers, that is, subcarrier channels, for transmission.

OFDM finds wide application in the digital transmission field such as DAB (Digital Audio Broadcasting), digital TV, WLAN (Wireless Local Area Network), and WATM (Wireless Asynchronous Transfer Mode). Although its hardware complexity has limited the implementation of OFDM in the past, the development of digital signal processing techniques including FFT (Fast Fourier Transform) and IFFT (Inverse Fast Fourier Transform) has made OFDM viable.

While OFDM is similar to the conventional FDM (Frequency Division Multiplexing), it offers optimal transmission efficiency in high-speed data transmission by maintaining orthogonality between subcarriers. Also, the advantages of high frequency use efficiency and robustness against multipath fading contribute significantly to the optimal transmission efficiency.

FIG. 1 is a block diagram of a transmitter 100 and a receiver 150 in a conventional OFDM mobile communication system.

Referring to FIG. 1, the transmitter 100 is comprised of a data transmitter 102, an encoder 104, a symbol mapper 106, a serial-to-parallel converter (SPC) 108, a pilot symbol inserter 110, an IFFT 112, a parallel-to-serial converter (PSC) 114, a guard interval inserter 116, a digital-to-analog converter (DAC) 118, and an RF (Radio Frequency) processor 120.

The data transmitter 102 generates user data bits and control data bits. The encoder 104 encodes the signal received from the data transmitter 102 in a predetermined coding scheme. The coding scheme can be turbo coding or convolutional coding with a predetermined coding rate. The symbol mapper 106 modulates the coded bits in a predetermined modulation scheme. The modulation scheme can be BPSK (Binary Phase Shift Keying), QPSK (Quadrature Phase Shift Keying), 16 QAM (Quadrature Amplitude Modulation) or 64 QAM.

The SPC 108 converts the serial modulation symbol sequence from the symbol mapper to parallel symbol sequences. The pilot symbol inserter 110 inserts pilot symbols into the parallel modulation symbols. The IFFT 112 performs an N-point IFFT on the output of the pilot symbol inserter 110.

The PSC 114 serializes the IFFT signals and the guard interval inserter 116 inserts a guard interval into the serial signal. The reason for inserting the guard interval is to cancel interference between an OFDM symbol at the previous OFDM symbol time and an OFDM symbol at the current OFDM symbol time.

The DAC 118 converts the signal from the guard interval inserter 116 to an analog signal. The RF processor 120, including elements such as a filter and front end units, processes the analog signal to an RF signal and transmits it over the air through a transmit (Tx) antenna.

The receiver 150 operates in the reverse order of transmitting a signal by the transmitter 100. The receiver 150 is comprised of an RF processor 152, an analog-to-digital converter (ADC) 154, a guard interval remover 156, an SPC 158, an FFT 160, a pilot symbol extractor 162, a channel estimator 164, an equalizer 166, a PSC 168, a symbol demapper 170, a decoder 172, and a data receiver 174.

A signal transmitted by the transmitter 100 experiences multipath fading, is added with noise, and arrives at a receive (Rx) antenna in the receiver 150. The RF processor 152 downconverts the received signal to an IF (Intermediate Frequency) signal. The ADC 154 converts the analog signal received from the RF processor 152 to a digital signal.

The guard interval remover 156 removes a guard interval from the digital signal. The SPC 158 converts the serial signal received from the guard interval remover 156 to parallel signals. The FFT 160 performs an FFT on the parallel signals and outputs the FFT signals to the equalizer 166 and the pilot symbol extractor 162. The equalizer 166 channel-equalizes the FFT signals, and outputs the signals to the PSC 168, which serializes the equalized signals.

Meanwhile, the pilot symbol extractor 162 detects pilot symbols from the FFT signals. The channel estimator 164 performs channel estimation using the pilot symbols and outputs the channel estimation result to the equalizer 166. The receiver 150 generates a CQI (Channel Quality Information) according to the channel estimation result and transmits it to the transmitter 100 through a CQI transmitter (not shown).

The symbol demapper 170 demodulates the serial signal received from the PSC 168 in a predetermined demodulation scheme. The decoder 172 decodes the demodulated signal in a predetermined decoding scheme. The demodulation and decoding schemes correspond to the modulation and coding schemes used in the transmitter 100.

Despite the advantages of the OFDM system, it faces the problem of high PAPR caused by multicarrier modulation. Because data is transmitted on multiple carriers, the amplitude of a final OFDM signal is the sum of the amplitudes of the carriers. Hence, the amplitude of the OFDM signal fluctuates greatly. If the carriers have the same phase, the amplitude variation is very great. As a result, the OFDM signal is outside the linear operational range of a linear HPA (High Power Amplifier) (not shown) and the output signal of the linear HPA suffers from distortion. Although the linear high power amplifier should operate its elements nonlinearly to achieve maximum output, it uses a back-off scheme to reduce input power and thus operate linearly due to the signal distortion. The back-off scheme drops the operational point of the linear HPA in order to mitigate signal distortion.

Typical PAPR reduction techniques for the OFDM communication system are clipping, block coding, phase adjustment, and tone reservation (TR).

Clipping is a scheme of setting a target clipping level such that the amplitude of a signal falls within the linear operational area of an amplifier, and if the signal amplitude is greater than the target clipping level, truncating the signal amplitude to the predetermined clipping level. However, clipping is a nonlinear process leading to in-band distortion, ISI generation, and increased BER (Bit Error Rate). Moreover, out-band clipping noise generates ICI (Inter-Channel Interference), decreasing spectrum efficiency.

Block coding is a process of coding additional carriers for PAPR reduction of the total carrier signal. This technique reduces PAPR without signal distortion as well as corrects errors owing to the coding. However, for many subcarriers, spectrum efficiency is very bad and the size of a look-up table or a generation matrix increases, resulting in an increase of computation volume.

The phase adjustment scheme includes PTS (Partial Transmit Sequence) and SLM (SeLective Mapping).

In the PTS scheme, input data is segmented into M subblocks. Each subblock is subject to an L-point IFFT and then multiplied by a phase factor that minimizes PAPR. The multiplication products are summed and transmitted. However, the PTS scheme requires as many IFFT operations as the number (M) of subblocks and a huge computation volume increasing with M. These problems are obstacles to high-speed data transmission.

In the SLM scheme, M identical data blocks are multiplied by statistically obtained different phase sequences of length N and a product having the lowest PAPR is selected for transmission. The SLM scheme has a distinctive shortcoming that M IFFT operations are required.

The PTS and SLM schemes commonly require transmission of additional information about rotation factors to a receiver in order to recover data. Transmission of the additional information on a channel makes communication complex and once an error is generated, the information of a corresponding OFDM symbol is defective.

In the TR scheme, some tones are reserved. The reserved tones do not carry data information and are used only for PAPR reduction. The receiver recovers an information signal from the other tones, neglecting the reserved tones. Thus, the receiver has a simple structure.

A common TR scheme is a gradient algorithm. The basic idea of the gradient algorithm comes from clipping. An impulsive signal is generated using tones that do not carry an information signal, and an IFFT signal is clipped by means of the impulsive signal. Addition of the impulsive signal to the IFFT signal causes distortion only to the information-free tones, with no distortion in data in the other frequency areas.

FIG. 2 is a block diagram of a typical TR-based transmitter. Referring to FIG. 2, total N subcarriers are divided into an L-tone reserved signal 201 (L) and an (N-L)-tone information signal 203. The transmitter is comprised of a tone allocator 205, a memory 207, a controller 209, an N-point IFFT 211 for IFFT-processing the total signals, a PSC 213, and a gradient algorithm unit 215.

The tone allocator 205 receives the reserved tone signal 201 at the N reserved tone locations and the information signal 203. The memory 207 has information corresponding to the L tone locations and impulsive wave information. Therefore, the controller 209 controls the tone allocator 205 to allocate the subcarrier locations referring to the location information and impulsive wave information in the memory 207. The tone allocator 205 inserts 0s at the L tone locations. The N-point IFFT 211 performs an IFFT on the output of the tone allocator 205. The PSC 213 converts the parallel IFFT signals to a serial signal x. The gradient algorithm unit 215 applies the gradient algorithm to the impulsive waves received from the controller 209 and adds the resulting scaling signal c and the signal x. The sum is transmitted to a receiver.

The reserved tone signal L and the information signal N-L received at the tone allocator 205 are expressed as Equation (1) and Equation (2) respectively.

$${C}_{k} = \{ \begin{matrix}{C}_{k} \cdot k ∈ \{ {i}_{1} , {i}_{2} , … , {i}_{1} \} \\ 0 \cdot k ∉ \{ {i}_{1} , {i}_{2} , … , {i}_{1} \}\end{matrix}$$

As noted from Equation (1), L subcarriers are reserved to be used for the scaling signal c and the L subcarrier locations {i₁, . . . , i_{L}} are fixed in the tone allocator 205 at an initial transmission. Here, i denotes the index of a reversed tone signal and k represents indices of frequency domain. An input signal X is allocated to subcarriers other than the signal c:

$${X}_{k} - \{ \begin{matrix}{X}_{k} \cdot k ∉ \{ {i}_{1} , {i}_{2} , … , {i}_{1} \} \\ 0 \cdot k ∈ \{ {i}_{1} , {i}_{2} , … , {i}_{1} \}\end{matrix} \qquad ( 2 )$$

Now a method of reducing PAPR using an impulsive P wave generated according to the impulsive wave information by the gradient algorithm unit 215 will be described below.

Let x^{clip} denote a vector obtained by clipping x to a predetermined level. Then,

$$x - {x}^{clip} = {\sum }_{i}^{} {β}_{i} δ [ n - {m}_{i} ] , x + c = {x}^{clip} .$$

where i denotes the number of iterations, βᵢ denotes a value to be clipped, mᵢ denotes a subcarrier location subject to clipping, δ denotes an ideal impulse function, and δ [n-mᵢ] means a cyclic shifing to mᵢ. Assuming that

$$c = - {\sum }_{i}^{} {β}_{i} δ [ n - {m}_{i} ] , x + c = {x}^{clip} .$$

It follows that the peak of the IFFT signal can be reduced to x^{clip} using c. Therefore, the signal c is interpreted as the sum of delayed, scaled impulse functions.

In the frequency domain, however, non-zero values are at most frequency locations, distorting data symbols at tone locations other than the reserved L tone locations. In this context, it is necessary to design a function that has 0s at locations other than the L reserved locations in the frequency domain and serves as an impulse function in the time domain, for use in clipping instead of an ideal impulse function.

Let 1_{L} denote a vector whose value is 1 at the reserved L tone locations and 0 elsewhere. If

$$P = P [ n ] = [ {P}_{0} , {P}_{1} , … , {P}_{N - 1} ] = \frac{\sqrt{N}}{L} IFFT ( {1}_{L} ) ,$$

P₀ is 1 and P₁, . . . , P_{N-1} are far less than P₀. For an ideal impulsive signal, P₁, . . . , P_{N-1} are 0s. To render the impulsive P waves to be approximate to the ideal impulsive signal, P₁, . . . , P_{N-1} must be small. Then, the peak variation of the IFFT output is minimized and the system PAPR is reduced.

FIG. 3 is a block diagram of a typical PAPR reducing apparatus using the gradient algorithm.

Referring to FIG. 3, the PAPR reducing apparatus is comprised of a P wave generator 301, a peak detector 303, a cyclic location shifter 305, a scaler 307, an adder 309, a PAPR calculator 311, and a controller 313.

The P wave generator 301 generates an impulsive P wave with the L tones reserved by the tone allocator 205. Meanwhile, the gradient algorithm unit 215 receives a time-domain IFFT signal x. The peak detector 303 in the gradient algorithm unit 215 detects the highest peak of the signal x. The cyclic location shifter 305 cyclically shifts the P wave to the location of the highest peak. The scaler 307 scales the shifted P wave so that the highest peak is at or below a target PAPR. If the scaling value is c, it is an optimal value with which to clip the peak of the IFFT output x.

The adder 309 adds x to c. The PAPR calculator 311 calculates the PAPR of the signal (x+c). If the calculated PAPR is higher than the predetermined PAPR, the controller 313 repeats the gradient algorithm until the PAPR is equal to or less than the predetermined PAPR. However, to prevent indefinite repetition of the gradient algorithm, the controller 313 sets a maximum repetition factor so that even if the calculated PAPR does not satisfy the predetermined PAPR, the signal is transmitted to the receiver.

FIG. 4 is a graph illustrating P waves generated in a typical P wave generator. Referring to FIG. 4, sample 0 has the highest power. Ideally, it is 1. While the ideal impulsive waves have a power value of 0 at sample locations other than the primary peak, the P waves from the P wave generator 301 have lower peaks at the other sample locations except for the primary peak. The highest peak at the other sample positions is called a secondary peak.

FIG. 5 is a block diagram of a secondary peak reducing apparatus using a conventional random set generation scheme.

Referring to FIG. 5, a random set generator 500 generates a random set by allocating 1s to L tones and 0s to the other tones among a total of N subcarriers. An IFFT 510 performs an IFFT operation on the random set and provides the resulting IFFT signal to a secondary peak detector 520 via a PSC (not shown). The secondary peak detector 520 detects a secondary peak from impulsive P waves of the IFFT signal and provides the secondary peak to a comparator 530 and a storage 540. The comparator 530 compares the detected secondary peak with a predetermined secondary peak. If the detected secondary peak is lower than the predetermined secondary peak, it is stored in the storage 540. The storage 540 also stores information about the L reserved tone locations of the randomly generated impulsive P waves. A controller 550 controls the above operation to be repeated as many times as a predetermined cyclic repetition factor. If the operation is repeated as many times as a predetermined maximum repetition factor, the controller 550 controls the storage 540 to output the L-tone location information. For example, if the maximum repetition factor is 10,000, the controller 550 controls the random set generator 500 to create 10,000 random sets and stores information indicating a tone location having the lowest of the secondary peaks of the random sets. The tone location information is provided to the gradient algorithm unit 215 illustrated in FIG. 2.

As described above, in the conventional random set generation method, L tones are randomly selected from a total of N subcarriers, and impulsive P waves having a low secondary peak, while shifting the L tone locations. Therefore, a total of _{N}C_{L} random sets can be created. If both N and L are sufficiently small, it is possible to detect an optimal impulsive P wave only through a census of all possible sets. On the other hand, if N or L becomes large, the census is impossible. Moreover, a current random set does not always lead to an impulsive wave having a lower secondary peak than the previous random set. Therefore, the operation cannot be carried out efficiently.

### SUMMARY OF THE INVENTION

An object of the present invention is to substantially solve at least the above problems and/or disadvantages and to provide at least the advantages below. Accordingly, an object of the present invention is to provide an apparatus and method for determining tone locations for efficient secondary peak reduction in generating an impulsive wave in an OFDM mobile communication system.

Another object of the present invention is to provide an apparatus and method for reducing a system PAPR by generating an impulsive wave having a lower secondary peak in an OFDM mobile communication system.

The above objects are achieved by providing a method of generating an impulsive wave in an orthogonal frequency division multiplexing (OFDM) communication system where L subcarriers are allocated to reserved tone locations among N subcarriers and data is carried on (N-L) subcarriers, L being less than N. The method comprises the steps of generating a predetermined number of random sets each having L tone locations, allocating subcarriers to the L tone locations of each of the random sets without overlapping, IFFT (Inverse Fast Fourier Transform)-processing the allocated subcarriers and storing a secondary peak value of the IFFT signal and detecting tone location information having a lower secondary peak value than the stored secondary peak value by fixing (L-1) tone locations and substituting subcarriers other than the subcarriers at the (L-1) tone locations for the remaining one tone location and storing the detected tone location information.

The above objects are achieved by providing an apparatus for generating an impulsive wave in an orthogonal frequency division multiplexing (OFDM) communication system where L subcarriers are allocated to reserved tone locations among N subcarriers and data is carried on (N-L) subcarriers, L being less than N. The apparatus comprises a tone information controller for generating a predetermined number of random sets each having L tone locations; a tone allocator for allocating subcarriers to the L tone locations of each of the random sets without overlapping; an IFFT (Inverse Fast Fourier Transform)-processor for processing the allocated subcarriers and storing a secondary peak value of the IFFT signal; and a tone location selector and inserter for detecting and inserting tone location information having a lower secondary peak value than the stored secondary peak value by fixing (L-1) tone locations and substituting subcarriers other than the subcarriers at the (L-1) tone locations one by one for the remaining one tone location and storing the detected tone location information.

### BRIEF DESCRIPTION OF THE DRAWINGS

The above and other objects, features and advantages of the present invention will become more apparent from the following detailed description when taken in conjunction with the accompanying drawings in which:

FIG. 1 shows a block diagram of a typical OFDM communication system;

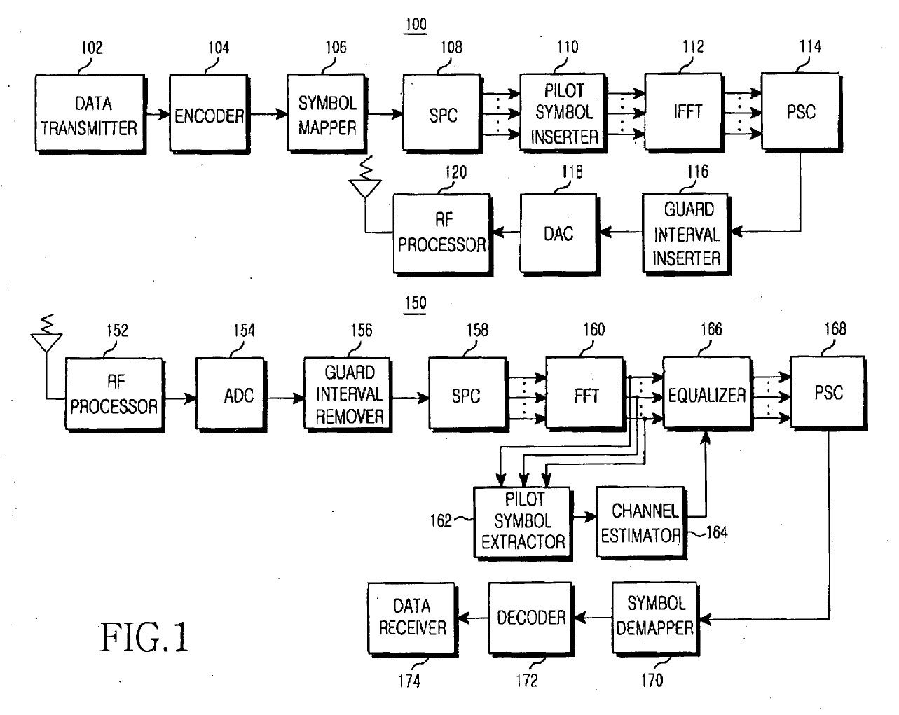

FIG. 2 shows a block diagram a typical TR-based transmitter;

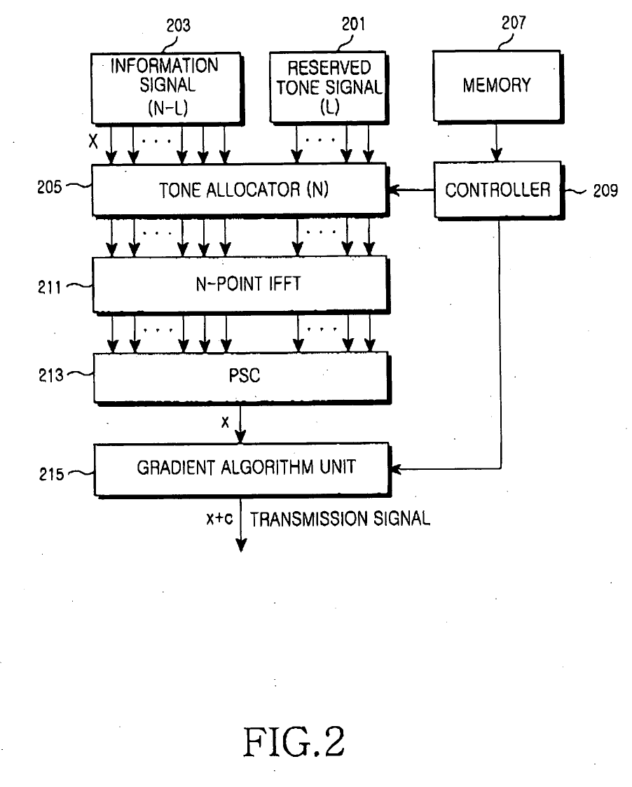

FIG. 3 shows a block diagram of a typical gradient algorithm unit;

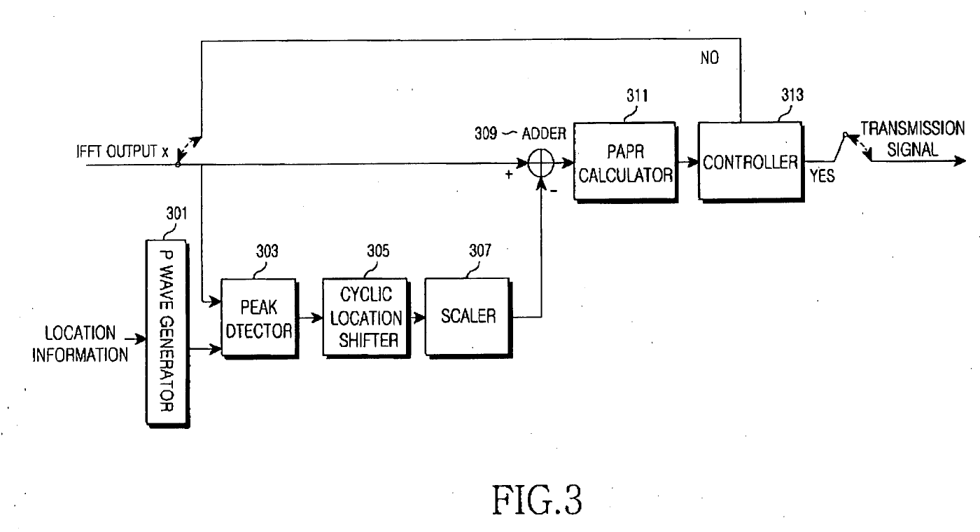

FIG. 4 shows a graph illustrating an impulsive wave generated in a typical P wave generator;

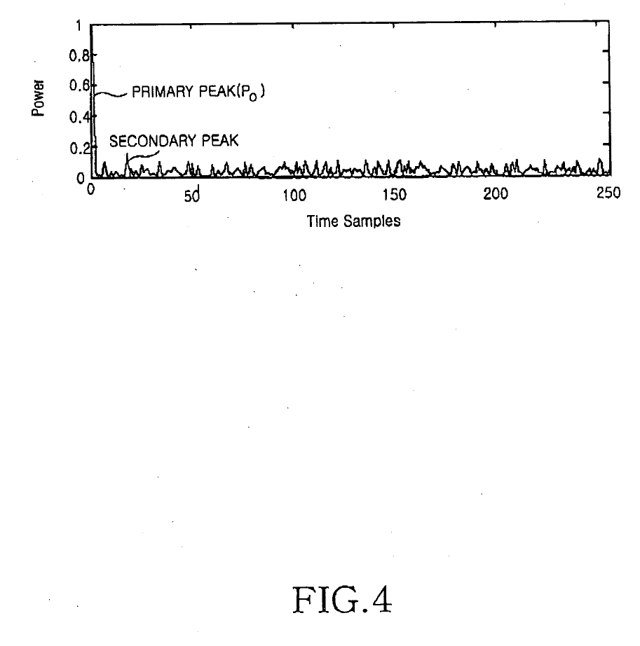

FIG. 5 shows a block diagram of a secondary peak reducing apparatus using a conventional random set generation method;

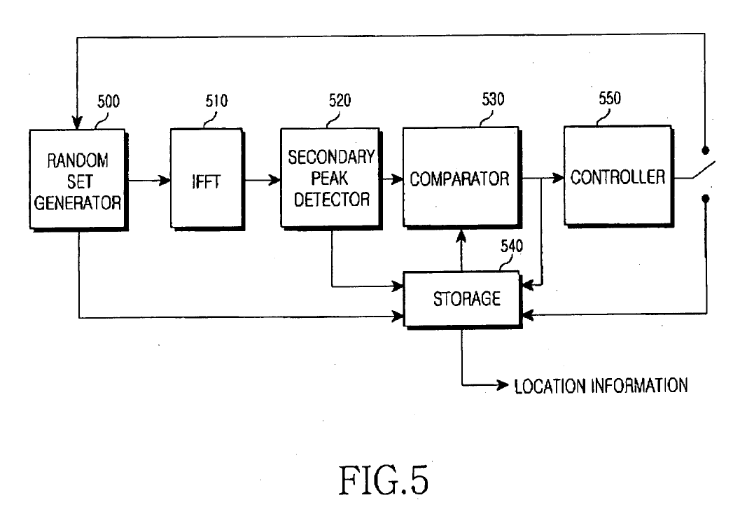

FIG. 6 shows a block diagram of a tone location information decider according to an embodiment of the present invention;

FIG. 7 shows a flowchart illustrating an operation for deciding tone location information according to the embodiment of the present invention;

FIG. 8 shows a flowchart illustrating an operation for deciding tone locations on a per-tone location basis according to the embodiment of the present invention; and

FIG. 9 shows a block diagram of a transmitter in an OFDM mobile communication system to which the embodiment of the present invention is applied.

### A DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention provides an apparatus and method for reserving some of IFFT input points and efficiently generating a P wave approximate to an ideal impulsive wave using the reserved points. The present invention is applicable to any of systems including an OFDM system as far as they generate an impulsive wave through IFFT.

Before describing the present invention, the term “impulsive wave” used herein is defined as a wave obtained by performing an IFFT operation on a random set of L tones. According to the present invention, the impulsive wave is a wave approximate to an ideal impulsive wave, generated according to final location information.

The phrase “optimum location information” indicates the tone locations of a random set having the lowest secondary peak. A plurality of random sets are generated and as many pieces of optimum location information as the number of the random sets are created. Optimum location information having the lowest secondary peak is chosen among the pieces of optimum location information. This optimum location information is called “final location information”.

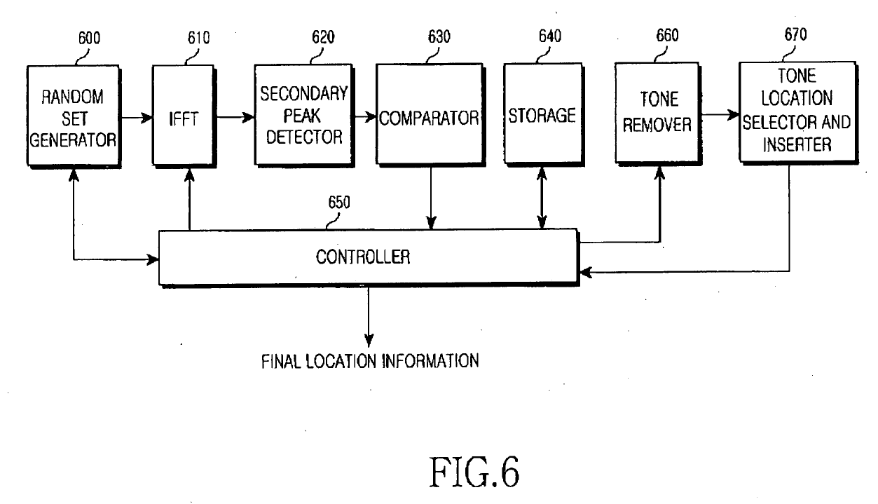

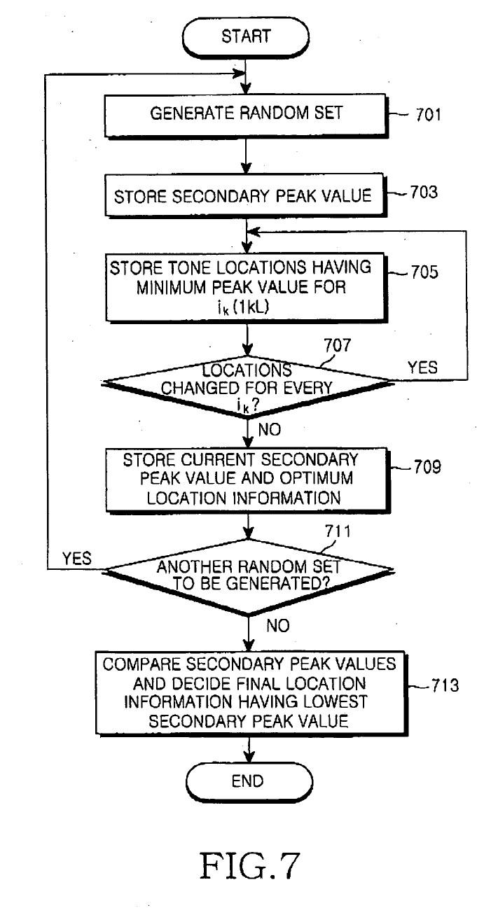

With reference to FIGS. 6 and 7, a description will be made of an apparatus and method for outputting tone location information with a reduced secondary peak in order to generate an impulsive P wave according to the present invention.

FIG. 6 is a block diagram of a tone location information decider for deciding tone location information according to an embodiment of the present invention.

Referring to FIG. 6, a random set generator 600 generates a random set having 1s at L tones and 0s elsewhere among a total of N subcarriers. An IFFT 610 generates an impulsive P wave by IFFT-processing the random set. A secondary peak detector 620 detects the secondary peak of the impulsive P wave. A comparator 630 compares the power of the secondary peak (hereinafter, the secondary peak value) with a secondary peak value predetermined by the system. The secondary peak value is appropriately set depending on system implementation, substantially larger than detected secondary peak values. If the secondary peak value of the impulsive P wave is lower than the predetermined secondary peak value, the comparator 630 stores the secondary peak value and tone location information of the impulsive P wave in a storage 640 under the control of a controller 650. On the contrary, if the secondary peak value of the impulsive P wave is higher than the predetermined secondary peak value, the comparator 630 transmits the comparison result to the controller 650.

The controller 650 controls a tone remover 660 to remove one tone location from the random set. The storage 640 stores information indicating the L tone locations of the impulsive P wave under the control of the controller 650.

Meanwhile, the controller 650 operates the tone remover 660 also when the secondary peak value stored in the storage 640 is updated to a new secondary peak value. The tone remover 660 removes a tone from an initial input according to the tone location information of a random set generated by the random set generator 600, and from the subsequent inputs according to the output of a tone location selector and inserter 670. The tone location selector and inserter 670 inserts another tone in the removed tone in the output of the tone remover 660 so as to minimize the secondary peak value. That is, the tone location selector and inserter 670 searches for a tone that offers a lower secondary peak value than the stored secondary peak value, inserts the searched tone in the removed tone location, and transmits information indicating the location of the selected and inserted tone (selection and insertion information) to the controller 650.

During the search and insertion operation of the tone location selector and inserter 670, a tone location satisfying a minimum secondary peak value is determined by trying a tone location except the unremoved tone locations, that is, N-(L-1) tone locations one by one into the removed tone location. The controller 650 then notifies the IFFT 610 of the new tone location information so that the IFFT 610 generates another impulsive P wave. The controller 650 controls the searching and insertion operation to be repeatedly performed on random sets until no change occurs to the secondary peak value and the tone location information.

The controller 650 controls the tone location information decider to operate according to a predetermined maximum random set number. That is, the controller 650 controls the random set generator 600 to generate as many random sets as the maximum random set number. After deciding optimum location information for each random set, the controller 650 selects optimum location information having the lowest secondary peak as final location information. Then an impulsive P wave is generated by allocating L tone locations in correspondence with the final location information.

FIG. 7 is a flowchart illustrating an operation for deciding tone location information according to the embodiment of the present invention.

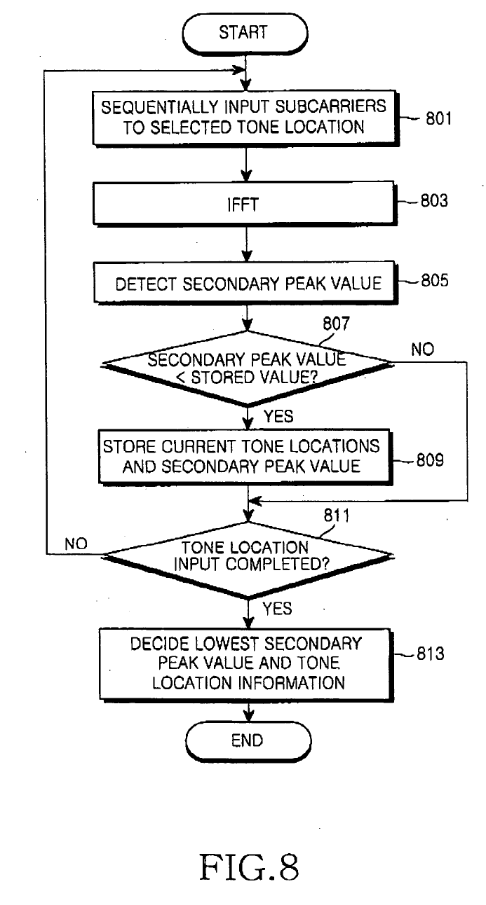

Referring to FIG. 7, the random set generator 600 generates a random set having 1s at randomly selected L tones and 0s elsewhere among a total of N subcarriers in step 701. The IFFT 610 performs an IFFT operation on the random set signal and stores the secondary peak value of the IFFT signal in the storage 640 in step 703. In step 705, the controller 650 stores tone location information offering the lowest secondary peak value for every iₖ in the storage 640 in step 705. Step 705 is carried out in the procedure illustrated in FIG. 8 and k ranges from 1 to L. In step 707, the controller 650 determines whether the secondary peak value and the tone location information have been changed for every iₖ. If they have been changed, step 705 is repeated. This will be described later in more detail with reference to Table 1. If no change has occurred to the secondary peak value and the tone location information, the controller 650 determines the current tone location information as optimum location information and stores the optimum location information and the secondary peak value in the storage 640 in step 709.

In step 711, the controller 650 determines whether the number of random sets generated so far is equal to a predetermined maximum random set number. If another random set is to be generated, the controller 650 returns to step 701. If the number of random sets generated so far is equal to the predetermined maximum random set number, the controller 650 compares one or more detected pieces of optimum location information and selects optimum location information having the lowest secondary peak value as final location information in step 713.

FIG. 8 is a flowchart illustrating a tone location deciding operation which is performed on a per-tone basis according to the embodiment of the present invention.

Referring to FIG. 8, the tone remover 660 removes one of the L tones of the random set and inserts one of N-(L-1) tones in the removed tone location in step 801. In step 803, the IFFT 610 performs an IFFT operation on the new signal. The secondary peak detector 620 detects the secondary peak value of the impulsive wave received from the IFFT 610 in step 805. The comparator 630 compares the detected secondary peak value with the currently stored secondary peak value in step 807. If the detected secondary peak value is lower than the currently stored secondary peak value, the procedure goes to step 809. On the contrary, if the detected secondary peak value is equal to or higher than the currently stored secondary peak value, the procedure jumps to step 811. In step 809, the controller 650 stores the detected secondary peak value and the tone location information of the new random set in the storage 640 and determines whether all tone locations except the unremoved tone locations are tried one by one in the removed tone location in step 811. If there remain tones to be processed, the procedure returns to step 801. In step 813, the controller 650 calculates the secondary peak values of signals each having one of N-(L-1) tones in the removed tone location and stores the secondary peak values and tone location information of the random sets in the storage 640.

The embodiment of the present invention will be described for N=64 and L=6 referring to Table 1.

TABLE 1

| | | | | | | | Secondary | Secondary |
|---|---|---|---|---|---|---|---|---|
| Run index | i₁ | i₂ | i₃ | i₄ | i₅ | i₆ | peak | peak (dB) |
| 1 | 17 | 19 | 59 | 2 | 21 | 40 | 0.608283 | −2.15894 |
| 2 | 13 | 19 | 59 | 2 | 21 | 40 | 0.503698 | −2.97830 |
| 3 | 13 | 19 | 59 | 2 | 21 | 40 | 0.503698 | −2.97830 |
| 4 | 13 | 19 | 35 | 2 | 21 | 40 | 0.434913 | −3.61598 |
| 5 | 13 | 19 | 35 | 4 | 21 | 40 | 0.391699 | −4.07047 |
| 6 | 13 | 19 | 35 | 4 | 17 | 40 | 0.375712 | −4.25144 |
| 7 | 13 | 19 | 35 | 4 | 17 | 40 | 0.375712 | −4.25144 |
| 8 | 44 | 19 | 35 | 4 | 17 | 40 | 0.350089 | −4.55822 |
| 9 | 44 | 19 | 35 | 4 | 17 | 40 | 0.350089 | −4.55822 |
| 10 | 44 | 19 | 35 | 4 | 17 | 40 | 0.350089 | −4.55822 |
| 11 | 44 | 19 | 35 | 4 | 17 | 40 | 0.350089 | −4.55822 |
| 12 | 44 | 19 | 35 | 4 | 17 | 40 | 0.350089 | −4.55822 |
| 13 | 44 | 19 | 35 | 4 | 17 | 40 | 0.350089 | −4.55822 |
| 14 | 47 | 10 | 11 | 12 | 13 | 14 | 0.892424 | −0.49429 |
| 15 | 51 | 10 | 11 | 12 | 13 | 14 | 0.729508 | −1.36970 |
| 16 | 51 | 60 | 11 | 12 | 13 | 14 | 0.508389 | −2.93030 |
| 17 | 51 | 60 | 8 | 12 | 13 | 14 | 0.397462 | −4.00704 |
| 18 | 51 | 60 | 8 | 36 | 13 | 14 | 0.364919 | −4.37804 |
| 19 | 51 | 60 | 8 | 36 | 13 | 14 | 0.364919 | −4.37804 |
| 20 | 51 | 60 | 8 | 36 | 13 | 14 | 0.364919 | −4.37804 |
| 21 | 51 | 60 | 8 | 36 | 13 | 14 | 0.364919 | −4.37804 |
| 22 | 51 | 17 | 8 | 36 | 13 | 14 | 0.345476 | −4.61583 |
| 23 | 51 | 17 | 8 | 36 | 13 | 14 | 0.345476 | −4.61583 |
| 24 | 51 | 17 | 8 | 36 | 13 | 14 | 0.345476 | −4.61583 |
| 25 | 51 | 17 | 8 | 36 | 46 | 14 | 0.340073 | −4.68427 |
| 26 | 51 | 17 | 8 | 36 | 46 | 14 | 0.340073 | −4.68427 |
| 27 | 19 | 17 | 8 | 36 | 46 | 14 | 0.340073 | −4.68427 |
| 28 | 19 | 17 | 8 | 36 | 46 | 14 | 0.340073 | −4.68427 |
| 29 | 19 | 17 | 8 | 36 | 46 | 14 | 0.340073 | −4.68427 |
| 30 | 19 | 17 | 8 | 36 | 46 | 14 | 0.340073 | −4.68427 |
| 31 | 19 | 17 | 8 | 36 | 46 | 14 | 0.340073 | −4.68427 |
| 32 | 19 | 17 | 8 | 36 | 46 | 14 | 0.340073 | −4.68427 |

For the operation illustrated in Table 1, the maximum number of random sets generated in the random set generator 600 is set to 2. As noted from Table 1, the two random sets generated from the random set generator 600 are labeled with run index 1 and run index 14. If the same secondary peak value results from inserting every available tone in each of six tone locations as run indexes 8 to 13and run indexes 27 to 32, the controller 650 determines the tone location information of run index 13, {44, 19, 35, 4, 17, 40} and the tone location information of run index 32, {19, 17, 8, 36, 46, 14}, as optimum location information for the two random sets, and selects {19, 17, 8, 36, 46, 14} as final location information because it offers the lower secondary peak value.

More specifically, let 6 (=L) tone locations selected among 64 (=N) subcarriers, from 0 to 63 be denoted by {i₁. i₂, i₃, i₄, i₅, i₆{. The random generator 600 generates a random set of subcarriers {17, 19, 59, 2, 21, 40} at a first run. The secondary peak detector 620 detects the secondary peak value 0.608283 of an impulsive P wave at the tone locations {17, 19, 59, 2, 21, 40}. At a second run, the tone remover 660 removes the first tone location 17 and the tone location selector and inserter 670 searches for a tone location for i₁ (i₁=13) which offers a lower secondary peak value, while trying every tone location for i₁ except {19, 59, 2, 21, 40}. The resulting secondary peak value is 0.503698. At a third run, the tone remover 660 removes the second tone location i₂=19 and the tone location selector and inserter 670 searches for a tone location for i₂ (i₂=19) which offers a lower secondary peak value, while trying every tone location for i₂ except {13, 59, 2, 21, 40}. The resulting secondary peak value is 0.503698.

The controller 650 repeats searching for tone locations for i₁ to i₆ at up to a seventh run, which otter a minimum secondary peak value. If none of the tone locations of i₁ to i₆ are changed during a tone location search operation, the minimum secondary peak detection operation is terminated for the random set. Since tone locations for i₁, i₃, i₄, and i₅ are changed at the second through seventh runs, the minimum secondary peak detection operation is repeated.

As 8^{th} through 13^{th} runs, there is no change in the secondary peak value for i₁ to i₆ and thus in the tone locations. Therefore, the storage 640 stores the final secondary peak value 0.350089 (−4.55822 dB) and the tone locations {44, 19, 35, 4, 17, 40}. The tone locations {44, 19, 35, 4, 17, 40} are optimum location information.

At a 14^{th} run, the random generator 600 generates another random set of subcarriers {47, 10, 11, 12, 13, 14}. The controller 650 controls the tone location selection and insertion to be repeated at 14^{th} through 32^{th} runs until no change occurs to a secondary peak value and tone locations. Finally, the controller 650 stores final subcarrier locations {19, 17, 8, 36, 46, 14} and a corresponding final secondary peak value 0.340073 (−4.68427 dB) in the storage 640. The secondary peak value 0.340073 is lower than the stored one 0.350089. Thus, the storage 640 substitutes the new tone location information {19, 17, 8, 36, 46, 14} and the final secondary peak value 0.340073 (−4.68427 dB) for the previous information. The tone location information {19, 17, 8, 36, 46, 14} is final location information.

The controller 650 controls the above operation until the number of random sets generated so far reaches a predetermined maximum random set number. That is, if the number of random sets generated so far exceeds the maximum random set number, the controller 650 stores final location information formed so far in the storage 640. Thus, a tone location search is performed more efficiently, and more reliably.

Table 2 below presents a performance analysis of the conventional random set generation method and the inventive impulsive wave search method. Simulations were performed under the conditions that N=256 and L=25, N=512 and L=50, and N=1024 and L=100. The same conditions are applied to the conventional method and the present invention. In the conventional random set generation method, a total of 1,000,000 random sets were generated and their secondary peak values were calculated. A random set of tone locations offering the lowest of the secondary peak values was selected. On the other hand, in the present invention, the secondary peak value is achieved in the manner described with reference to Table 1. To apply the same conditions, the controller 650 controls the tone location search in the manner that prevents the number of runs of the tone location selection and insertion operation from exceeding 1,000,000. The simulation results are as follows.

TABLE 2

| | method | | | |
|---|---|---|---|---|
| | Random | | | |
| | set generation | | Tone location search | |
| | Secondary | Secondary | Secondary | Secondary |
| variables | peak | peak (dB) | peak | peak (dB) |
| N = 256, L = 25 | 0.100213 | −9.9908 | 0.079221 | −11.0116 |
| N = 512, L = 50 | 0.061282 | −12.1267 | 0.043045 | −13.6607 |
| N = 1024, L = 100 | 0.043743 | −13.5909 | 0.029192 | −15.3473 |

Table 2 shows that the tone location search according to the embodiment of the present invention produces lower secondary peaks than the conventional random set generation method under the three conditions.

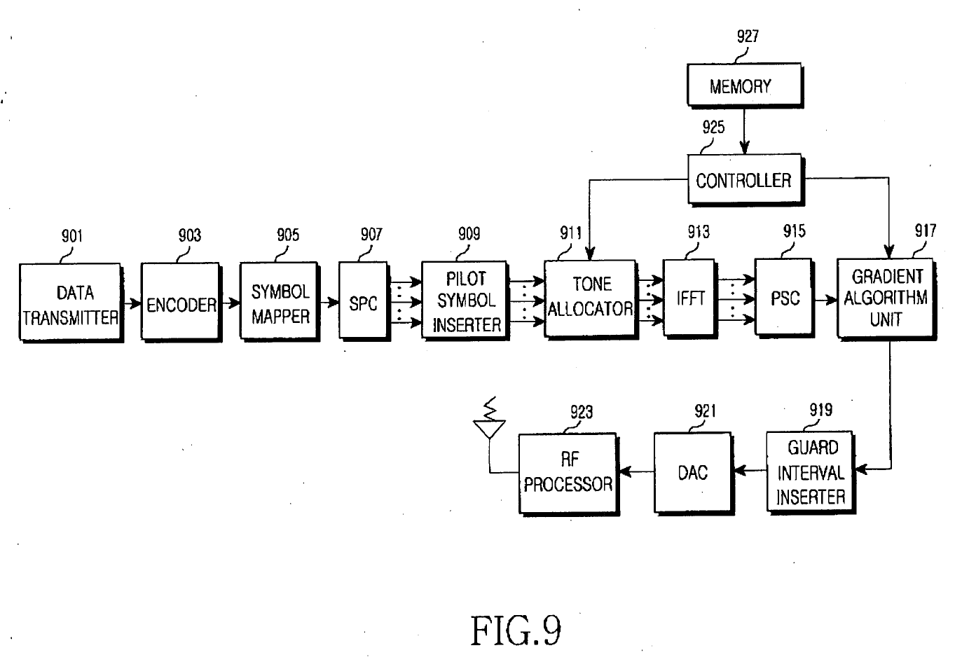

FIG. 9 is a block diagram of a transmitter in an OFDM mobile communication system to which the embodiment of the present invention is applied.

Referring to FIG. 9, the transmitter is comprised of a data transmitter 901, an encoder 903, a symbol mapper 905, an SPC 907, a pilot symbol inserter 909, a tone allocator 911, an IFFT 913, a PSC 915, a gradient algorithm unit 917, a guard interval inserter 919, a DAC 921, an RF processor 923, a controller 925, and a memory 927. The controller 925 and the memory 927 may collectively form the tone location information decider illustrated in FIG. 6 according to the present invention.

The data transmitter 901 generates user data bits and control data bits. The encoder 903 encodes the signal received from the data transmitter 901 in a predetermined coding scheme. The coding scheme can be turbo coding or convolutional coding with a predetermined coding rate. The symbol mapper 905 modulates the coded bits in a predetermined modulation scheme. The modulation scheme can be BPSK, QPSK, 16 QAM, or 64 QAM.

The SPC 907 converts the serial modulation symbol sequence to parallel modulation symbol sequences. The pilot symbol inserter 909 inserts pilot symbols into the parallel modulation symbols. The tone allocator 911 allocates L tones that do not carry information at reserved locations based on tone location information offering a minimum secondary peak value received from the controller 925.

The IFFT 913 performs an N-point IFFT operation on the output of the tone allocator 911. The PSC 915 serializes the parallel IFFT signals. The gradient algorithm unit 917 transmits a signal having a minimum PAPR achieved by a gradient algorithm. That is, the gradient algorithm unit 917 generates an impulsive P wave according to final location information received from the controller 925. The guard interval inserter 919 inserts a guard interval to the output of the gradient algorithm unit 917.

The DAC 921 converts the digital signal received from the guard interval inserter 919 to an analog signal. The RF processor 923, including a filter and front end units, processes the analog signal to an RF signal and transmits the RF signal over the air through a Tx antenna. The controller 925 transmits the final location information received from the memory 927 to the tone allocator 911 and the gradient algorithm unit 917 in order to control generation of the impulsive P wave having a lower secondary peak value. Therefore, the memory 927 already has the final location information. The final location information is detected only once during the final location information deciding operation. It can be stored in the memory 927 or vary with IFFT points.

In accordance with the present invention as described above, the present invention advantageously decides final tone location information offering a reduced secondary peak value efficiently, reliably in an OFDM mobile communication system. In addition, generation of an impulsive wave using the final tone location information reduces a system PAPR.

While the invention has been shown and described with reference to a certain preferred embodiment thereof, it will be understood by those skilled in the art that various changes in form and details may be made therein without departing from the spirit and scope of the invention as defined by the appended claims.

1. A method of generating an impulsive wave in an orthogonal frequency division multiplexing (OFDM) communication system where L subcarriers are allocated to reserved tone locations among N subcarriers and data is carried on (N-L) subcarriers, L being less than N, comprising the steps of:
generating a predetermined number of random sets each having L tone locations;
allocating subcarriers to the L tone locations of each of the random sets without overlapping;
IFFT (Inverse Fast Fourier Transform)-processing the allocated subcarriers and storing a secondary peak value of the IFFT signal; and
detecting tone location information having a lower secondary peak value than the stored secondary peak value by fixing (L-1) tone locations and substituting subcarriers other than the subcarriers at the (L-1) tone locations for the remaining one tone location and storing the detected tone location information.

2. The method of claim 1, wherein the tone location information detecting step is performed for the L tone locations on a per-tone location basis.

3. The method of claim 2, wherein the tone location information detecting step comprises the step of, determining the stored tone location information as minimum peak to average power ratio (PAPR) information for the random set, if the secondary peak value is not changed L times.

4. The method of claim 3, wherein the subcarriers allocated to the L tone locations are 1s.

5. The method of claim 4, wherein the subcarriers allocated to the (N-L) tone locations are 0s.

6. An apparatus for generating an impulsive wave in an orthogonal frequency division multiplexing (OFDM) communication system where L subcarriers are allocated to reserved tone locations among N subcarriers and data is carried on (N-L) subcarriers, L being less than N, comprising:
a tone information controller for generating a predetermined number of random sets each having L tone locations;
a tone allocator for allocating subcarriers to the L tone locations of each of the random sets without overlapping;
an IFFT (Inverse Fast Fourier Transform)-processor for processing the allocated subcarriers and storing a secondary peak value of the IFFT signal; and
a tone location selector and inserter for detecting and inserting tone location information having a lower secondary peak value than the stored secondary peak value by fixing (L-1) tone locations and substituting subcarriers other than the subcarriers at the (L-1) tone locations one by one for the remaining one tone location and storing the detected tone location information.

7. The apparatus of claim 6, further comprisestone location selector and inserter performs the tone location information detecting operation on the L tone locations on a per-tone location basis.

8. The apparatus of claim 6, further comprises a memory for storing a predetermined secondary peak value, a new secondary peak value calculated each time a new subcarrier is allocated to one of the L tone locations, and subcarrier location information having a minimum peak to average power ratio (PAPR).

9. The apparatus of claim 6 further comprises a controller for, if the secondary peak value is not changed L times, determining the stored tone location information as the subcarrier location information having a minimum PAPR information for the random set.
